(19) United States
(12) Patent Application Publication
(10) Pub. No.: US 2006/0136489 A1
(43) Pub. Date: Jun. 22, 2006

(54) Mapping a semantic model of business collaboration to a web services meta model

(76) Inventors: Frank Thome, Karlsruhe (DE); Gunther Stuhec, Heidelberg (DE)

Correspondence Address: FISH & RICHARDSON, P.C., PO BOX 1022, MINNEAPOLIS, MN, 55440-1022, US

(21) Appl. No.: 11/016,112

(22) Filed: Dec. 17, 2004

(51) Int. Cl. G06F 7/00

(52) U.S. Cl. 707/103 R

(57) ABSTRACT

Methods and apparatus, including computer program products, for modeling a business collaboration. A data model includes an interface class, an operation class, and a message class for use in a web services architecture. The interface class includes one or more operations, and each instance of the interface class corresponds to a business transaction pattern of a business collaboration. The business transaction pattern includes one or more business transaction activities. The operation class represents one or more operations associated with an instance of the interface class. Each instance of the operation class corresponds to a business transaction activity of the business collaboration. The message class represents one or more message types for each instance of the operation class.

### BACKGROUND

The present invention relates to data processing by digital computer, and more particularly to mapping a semantic model of business collaboration to a web services meta model.

The design process for complex software applications generally begins with constructing a model of the software architecture. In an object-oriented design process, for example, a model allows a designer to define the structure and interaction of a large number of software modules before actual software coding begins. The development of a model can also promote reuse of modules within an application (or between applications) by facilitating an organized representation of the application. The ability to reuse modules can also facilitate at least partially automated application code generation. For example, if a model for a new application reuses software modules from a prior application, it is possible to automatically generate some of the code for the new application by using the code from the prior application.

An application can be modeled, for example, using the Unified Modeling Language (UML) to create a visual representation of the application. Models defined using UML can easily be translated into metadata that can be stored in a repository (e.g., using Extensible Markup Language (XML) Metadata Interchange (XMI)). Web services and/or applications that implement web services can be modeled using a UML class diagram, which can be converted into Web Services Description Language (WSDL) to describe the mechanics of interacting with a particular web service. WSDL provides a framework for describing the syntax of a web service by defining message types, interfaces, operations, and bindings.

The UN/CEFACT Modeling Methodology (UMM) defines the business semantics of a business collaboration without considering any specific exchange technology. The UMM meta model is organized into a Business Domain View (BDV) meta model, a Business Requirements View (BRV) meta model, a Business Transaction View (BTV) meta model, and a Business Service View (BSV) meta model. These different views support a model construction methodology for describing collaborative business processes from multiple perspectives.

### SUMMARY OF THE INVENTION

The present invention provides methods and apparatus, including computer program products, that implement techniques for modeling a business collaboration.

In one general aspect, the techniques feature a data model that includes an interface class, an operation class, and a message class for use in a web services architecture. The interface class includes one or more operations, and each instance of the interface class corresponds to a business transaction pattern of a business collaboration. The business transaction pattern includes one or more business transaction activities. The operation class represents one or more operations associated with an instance of the interface class. Each instance of the operation class corresponds to a business transaction activity of the business collaboration. The message class represents one or more message types for each instance of the operation class.

The invention can be implemented to include one or more of the following advantageous features. The data model includes a naming convention for components of a business transaction. Business transactions are the primary business process parts described in UN/CEFACT Modeling Methodology (UMM). Each business transaction that conforms to the naming convention includes component terms identifying an intention, an action, a transaction activity, and an object associated with the business transaction. A message name associated with an instance of the message class includes the component terms identifying an intention, an action, a transaction activity, and an object associated with the business transaction. The component terms include an intention term identifying the intention, an action term identifying the action, and a transaction term identifying the transaction activity. The intention term is selected from a predefined set of intention terms, the action term is selected from a predefined set of action terms, and the transaction term is selected from a predefined set of transaction terms.

The naming convention involves assigning an interface name to each instance of the interface class and assigning an operation name to each instance of the operation class. The interface name includes a term associated with the business transaction pattern that corresponds to the interface class instance. The operation name includes a term associated with the business transaction activity that corresponds to the operation class instance. The business collaboration is represented by a semantic model, and the web services are modeled by the interface class, the operation class, and the message class. Each component of the semantic model corresponds to a class of the web services model. The business transaction pattern is included in a set of predefined transaction patterns. Each predefined transaction pattern includes one or more corresponding predefined transaction activities. The message class corresponds to a business transaction message of the business collaboration. The data model further includes an object class representing an object associated with each instance of the message class. The object class corresponds to a business transaction object of the business collaboration.

Each instance of the interface class includes an interface name that includes component terms identifying the business transaction pattern corresponding to the interface class instance and a business object associated with the interface class instance. Each instance of the operation class includes an operation name that includes a component term identifying the business transaction activity corresponding to the operation class instance. Each instance of the message class includes a message name comprising a component term identifying the business transaction activity corresponding to an operation class instance associated with the message class instance and a business object associated with the message class instance.

In another general aspect, a repository stores meta data defining a data model and a computer is operable to retrieve meta data from the repository and to generate a message in accordance with the retrieved meta data. The message includes an instance of an interface class that includes one or more operations. The instance of the interface class corresponds to a business transaction pattern of a business collaboration, and the business transaction pattern includes one or more business transaction activities. The message also include an instance of an operation class that represents one or more operations associated with the instance of the interface class. The instance of the operation class corresponds to a business transaction activity of the business collaboration. The message further includes an instance of a message class that represents one or more message types for the instance of the operation class.

The invention can be implemented to realize one or more of the following advantages. The meta model of the Business Transaction View (BTV) provides a semantic level description of a business collaboration that can be mapped to a syntactic level description of an electronic business framework, such as that provided by WSDL. In addition, the invention provides a consistent naming convention for parts of a business collaboration. The naming convention can be used for classification of messages, providing semantic information to business partners regarding the content of the messages, and removing complexity from business transactions. The invention also helps realize a controlled library of business process terms for easily finding business processes or process parts that match specific semantic requirements and supports higher reusability of terms through a consistent definition of the common semantic parts of a business process. One implementation of the invention provides one or more of the above advantages.

Details of one or more implementations of the invention are set forth in the accompanying drawings and in the description below. Further features, aspects, and advantages of the invention will become apparent from the description, the drawings, and the claims.

### BRIEF DESCRIPTION OF THE DRAWINGS

FIG. 1 is a block diagram of a system for transacting electronic business using a business communication schema.

FIG. 2 illustrates transaction patterns and transaction activities between a sender and a receiver.

FIG. 3 is a WSDL meta model class diagram.

FIG. 4 illustrates a mapping of UMM transaction patterns and the corresponding transaction activities to WSDL operations.

FIG. 5 illustrates a mapping of components in a business collaboration model to elements of the WSDL meta model.

FIG. 6 is a flow diagram of a process for modeling a business collaboration.

Like reference numbers and designations in the various drawings indicate like elements.

### DETAILED DESCRIPTION

In general, electronic business communications can be conducted using electronic documents. An electronic document does not necessarily correspond to a file. A document may be stored in a portion of a file that holds other documents, in a single file dedicated to the document in question, or in multiple coordinated files. An electronic document used in transacting electronic business is formatted in accordance with one of a wide variety of available business communication schemas (e.g., EDIFACT, X12, xCBL, or IDoc). An electronic document can correspond to an electronic business message, transaction, group of related messages, or group of related transactions.

Each business communication schema includes a set of business data elements from which electronic documents can be constructed. For example, a purchase order electronic document can be constructed using an aggregation of business data elements that specify the buyer and the seller, identify the document as a purchase order, list the ordered products, specify delivery terms, and provide other relevant information. A communication schema is typically defined using XML.

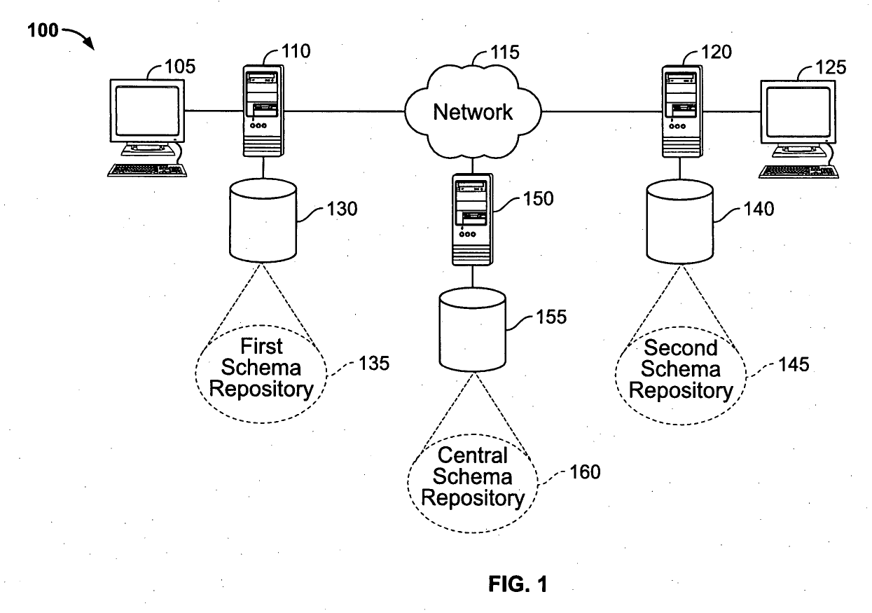

FIG. 1 is a block diagram of a system 100 for transacting electronic business using a business communication schema. The system 100 includes a first monitor 105 connected to a first computer 110 and a second monitor 125 connected to a second computer 120. Electronic business communications between the first computer 110 and the second computer 120 are conducted over a network 115, such as the Internet, in accordance with a business communication schema. To facilitate electronic business communications, the first computer 110 includes a data storage device 130 containing a first schema repository 135 and the second computer 120 includes a data storage device 140 containing a second schema repository 145. Each of the first schema repository 135 and the second schema repository 145 store metadata describing one or more formats, message types, operations, interfaces, and services defined by a business communication schema.

To exchange electronic documents between the computers 110 and 120 using a consistent syntax, the schema that is defined in the first schema repository 135 and the second schema repository 145 are retrieved over the network 115 from a remote server 150. The remote server 150 includes a storage device 155 containing a central schema repository 160. The central schema repository 160 includes metadata defining one or more communication schemas. Typically, an electronic document identifies an addressable namespace corresponding to the remote server 150 and also may identify other addressable namespaces at the remote server 150 or at other servers. The addressable namespaces provide a logical location from which metadata describing a business communication schema can be retrieved if the metadata is not already known or if it needs to be updated.

The monitor 105 displays user interfaces for allowing a user to enter or otherwise define business data to be included in an electronic document. The first computer 110 generates the electronic document in accordance with the metadata stored in the first schema repository 135. In particular, the first computer 110 organizes the data entered by the user according to a communication schema defined in the first schema repository 135. The generated electronic document can then be transmitted over the network 115 to a receiving entity, such as the second computer 120. The second computer 120 is capable of interpreting received electronic documents in accordance with the metadata stored in the second schema repository 145. In particular, the second computer 120 interprets data contained in a received electronic document according to a communication schema defined in the second schema repository 145. If the schema is not already defined in the second schema repository 145, metadata describing the schema can be retrieved over the network 115 from the remote server 150.

Different characteristics of a business collaboration between two computers 110 and 120 can be modeled separately. For example, business semantics can be modeled separately from the syntax of an electronic business framework. In accordance with the present invention, a business semantics meta model is mapped to a meta model for defining the syntax of a business collaboration. In addition, a naming convention can be defined for clearly communicating the semantic meaning of business collaboration elements to business partners.

The business semantics of a business collaboration between two or more business partners (e.g., each corresponding to one of the computers 110 and 120) can be defined using the UMM meta model. Within this meta model, the BTV (Business Transaction View) defines the choreography of a business collaboration and structures the business information exchanged. Typically, a business collaboration is very complex and involves a large number of activities between business partners. The most basic business collaboration is a binary collaboration, which is realized by a request from one partner and an optional response from the other partner. A binary collaboration is a unit of work within an overall business collaboration and corresponds to a business transaction. A business transaction is a unit of work through which information and signals are exchanged (in an agreed format, sequence, and time interval) between two business partners. A business transaction is complete when all the interactions within it succeed; otherwise, the business transaction is rolled back to a defined state that existed before the business transaction was initiated.

The parts of a business transaction used to exchange information are called business actions. In general, business actions are either requesting business activities or responding business activities depending on whether the business actions are performed by a partner who is requesting a business service or whether the business actions are performed in response to such a request. These business actions are comparable to an illocution act for sending or receiving business information in the form of business objects.

A business action in the context of UMM can be described in terms of an intention, an action, and a transaction. In addition, business actions generally relate to a business object. By generating a name for a business message that identifies the intention, action, transaction activity (or transaction pattern), and business object associated with the business message, the message can be more easily classified and semantic information about the business message can be communicated to a receiving business partner without having to examine the contents of the message. The name of business information exchanged in a business action can therefore include terms that provide a complete and unambiguous description of the business action.

A “transaction pattern” is a type of pattern that defines an atomic unit of work in collaboration. A business transaction includes one requesting business activity involving a business object and, in some cases, one responding business activity involving the business object. The types of two-way transaction patterns include, for example, “commercial transaction,” “request/response,” “query/response,” and “request/confirm,” while the one-way transaction pattern types include “notification” and “information.” For two-way communications, each transaction pattern includes a transaction activity for each directional communication. One-way communications have only one transaction activity.

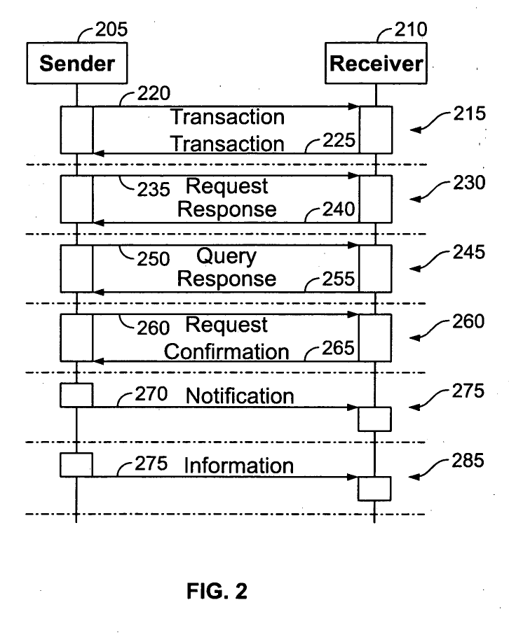

As shown in FIG. 2, each transaction pattern represents a business action between a sender 205 and a receiver 210. A “commerical transaction” (or simply “transaction”) pattern type 215 is used for interactions that result in economic commitments among business partners (e.g., offer and acceptance) and, thus, generally involves non-repudiation and authentication. The transaction activities from the sender 205 to the receiver 210 and from the receiver 210 to the sender 205 are each called a “transaction” 220 and 225. A “request/response” pattern type 230 is used for business contracts when an initiating partner requests information that a responding partner already has and when the request for business information requires a complex interdependent set of results (e.g., for requesting price and availability and receiving a response). The “request/response” pattern type 230 includes a “request” transaction activity 235 from the sender 205 to the receiver 210 and a “response” transaction activity 240 from the receiver 210 to the sender 205.

A “query/response” pattern type 245 is used for information that a responding partner already has, for example, in a fixed data set that resides in a database (e.g., for requesting and obtaining a list of products that meet certain criteria). The response comprises zero or more results each of which meets the constraining criteria in the query. The “query/response” pattern type 245 includes a “query” transaction activity 250 from the sender 205 to the receiver 210 and a “response” transaction activity 255 from the receiver 210 to the sender 205. A “request/confirm” pattern type 260 is used for business contracts where an initiating partner requests confirmation about status with respect to previously established contracts or with respect to a responding partner's business rules (e.g., for requesting and receiving confirmation that the responding partner is authorized to sell certain products). The “request/confirm” pattern type 260 includes a “request” transaction activity 265 from the sender 205 to the receiver 210 and a “confirmation” transaction activity 270 from the receiver 210 to the sender 205.

A “notification” pattern type 275 specifies an exchange of a notifying business document (and the return of an acknowledgement of receipt signal) and is used to model a formal information exchange business transaction that typically has non-repudiation requirements. The “notification” pattern type 275 includes a “notification” transaction activity 280. An “information” pattern type 285 specifies the exchange of a requesting business document (and the return of an acknowledgement of receipt signal) and is used to model an informal information exchange business transaction that typically has no non-repudiation requirements. The “information” pattern type 285 includes an “information” transaction activity 290.

An “intention” term defines the sender's intent with respect to a business object. Allowed values for the intention term include, for example, “propose,” “accept,” “reject,” “declare,” “query,” “reply,” “assert,” and “action.” A value of “propose” means that the sender proposes to create, change, or cancel a business object. A value of “accept” means that the sender accepts a previous proposal. A value of “reject” means that the sender rejects a previous proposal. A value of “declare” means that the sender unilaterally creates, changes, or cancels a business object. A value of “query” means that the sender is asking for information. A value of “reply” means that the sender is replying to a previous query. A value of “assert” means that the sender makes a statement about one or more business objects.

An “action” term defines an instruction to the recipient of a message telling the recipient how to process a transmitted business object. Allowed values for the action term include, for example, “create,” “change,” “delete,” “save,” and “remove.” A value of “create” means the business object does not already exist and is to be created at the recipient. A value of “change” means the business object exists and is to be changed at the recipient. A value of “delete” means the business object exists and is to be deleted at the recipient. A value of “save” means the business object is to be created, if it does not already exist, and saved at the recipient. A value of “remove” means the business object is to be deleted at the recipient. An absent or null action term value means that the recipient need not take any action for the business object.

The syntax of a business information exchange can be modeled using WSDL. The WSDL model defines classes for abstract message contents and deployment information. Accordingly, WSDL includes eight basic elements, which can be divided into abstract and concrete elements.

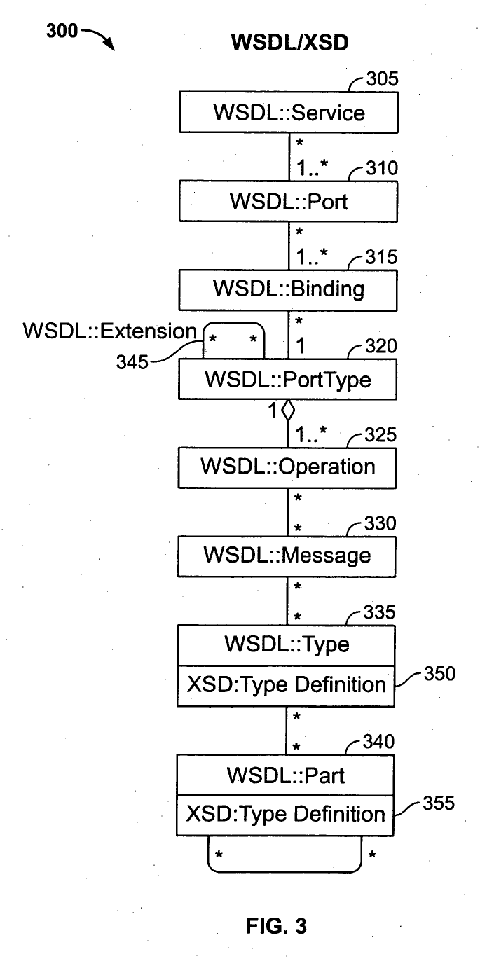

As shown in FIG. 3, a meta model class diagram 300 includes elements of WSDL and XML Schema Definition (XSD) and is constructed using UML class modeling. WSDL defines a service class 305, a port class 310, a binding class 315, a portType class 320, an operation class 325, a message class 330, a type class 335, and a part class 340. The service class 305 represents a collection of related endpoints and defines an address (e.g., a URL) for invoking a particular web service. Each instance of the service class 305 is associated with one or more instances of the port class 310. The port class 310 represents an endpoint as a combination of a binding and a network address. Each instance of the port class is associated with one or more instances of the binding class 315. The binding class 315 describes how to access a web service by specifying concrete protocols and data formats for a particular port type. Instances of the binding class 315 allow bindings for different protocols, such as SOAP, HTTP, and MIME. The service class 305, port class 310, and binding class 315 represent concrete elements that are specified only at runtime configuration.

The remaining classes in WSDL represent abstract elements. The portType class 320 (or interface class in WSDL 2.0) describes an abstract set of operations supported by one or more endpoints. Each instance of the portType class 320 combines multiple message elements to define a complete one-way or roundtrip communication. One or more instances of the portType class 320 can be extended (345) by one or more other instances of the portType class 320 (i.e., to incorporate elements of one or more portType instances into another portType instance). Each portType instance includes one or more instances of the operation class 325. The operation class 325 describes an abstract action supported by a service. In general, an operation describes a sequence of messages that can be exchanged with the web service. Operations are associated with instances of a message class 330, which defines the abstract message elements within an operation for communicating information. The message class 330 includes input messages, output messages, and fault messages. The type class 335 is an abstract container for data type definitions 350 that is based on XML Schema (XSD). The part class 340 separates the message content into logically separate data. Each part instance is an element of a specific data type 355, which is based on XML Schema (XSD).

The business semantics provided by the UMM meta model can be mapped into the WSDL syntax. In particular, the business transaction view of UMM is mapped to the abstract level of WSDL.

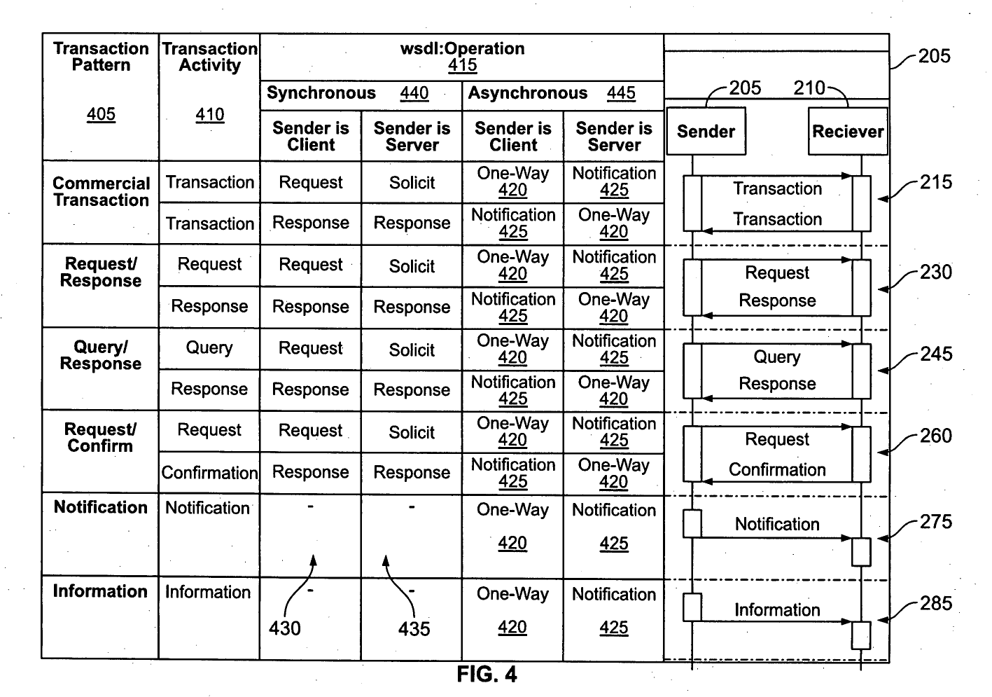

As shown in FIG. 4, UMM transaction patterns 405 and the corresponding transaction activities 410 are mapped to WSDL operations 415. WSDL uses four types of operations: one-way operations 420, notification operations 425, request/response operations 430, and solicit/response operations 435. The mapping of transactions patterns 405 and transaction activities 410 to WSDL operations 415 is dependent upon whether the communication is synchronous 440 or asynchronous 445 and whether the sender 205 or receiver 210 is acting as the client or the server. For synchronous communications 440, the commercial transaction pattern 215, the request/response pattern 230, the query/response pattern 245, the request/confirm pattern 260, and the corresponding directional transaction activities are mapped to the request/response operation 430 when the sender 205 is the client, and to the solicit/response operation 435 when the sender 205 is the server. There are no operations corresponding to notification or information patterns 275 and 285 for synchronous communications 440. For asynchronous communications 445, the commercial transaction pattern 215, the request/response pattern 230, the query/response pattern 245, the request/confirm pattern 260, and the corresponding directional transaction activities are mapped to the one-way operation 420 and the notification operation 425 when the sender 205 is the client, and to the notification operation 425 and the one-way operation 420 when the sender 205 is the server. The notification and information transaction patterns 275 and 285 and transaction activities 280 and 290 are mapped to the one-way operation 420 when the sender is the client 205 and to the notification operation 425 when the sender 205 is the server.

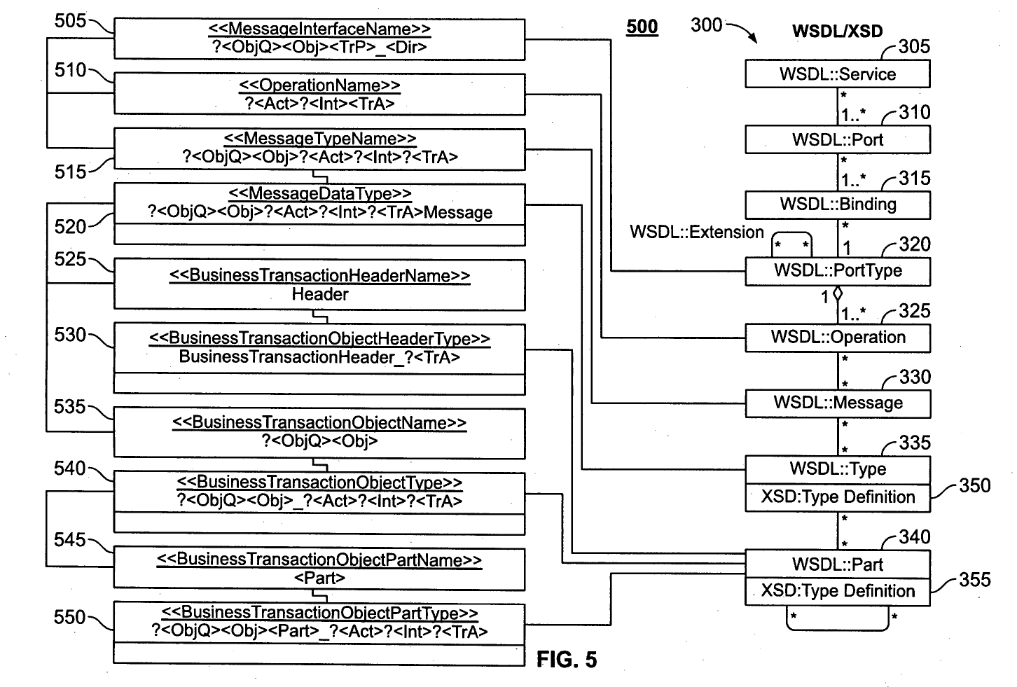

As shown in FIG. 5, components of a business collaboration model are mapped to elements of the WSDL meta model. A message interface component 505 defines a UMM business transaction between two business application components. The message interface component 505 corresponds to one of the six transaction patterns (see FIG. 2). The business transaction patterns are based on two WSDL portTypes, which represent the endpoints of the client and server. Each portType includes one or more operations. For each endpoint, one corresponding message interface is defined, one at the client (_OUT) and one at the server (_IN).

The message interface component 505 includes an operation component 510 and a message type component 515. The operation component 510 defines a transaction activity of a UMM business transaction (see FIG. 2) and corresponds to a WSDL operation. Each business transaction activity is mapped to one of the four types of WSDL operations (i.e., one-way operations 420, notification operations 425, request/response operations 430, and solicit/response operations 435, as shown in FIG. 4) based on the type of communication (synchronous or asynchronous) and the role of the sender and recipient parties (client or server). In addition, a fault operation can be also defined for use when an error occurs. The message type component 515 defines a root element of the message, which represents the UMM business information exchanged between the business applications. The message type component 515 corresponds to a WSDL message and represents an input, output or fault message.

The message type component 515 is based on a message data type component 520, which identifies the complete structure of the message. The message data type component 520 corresponds to a WSDL type and is based on standard XML Schema (XSD) datatypes. The message data type component 520 includes a business transaction header component 525 and a business transaction object component 535. The business transaction header component 525 defines business information from the perspective of the sender application for identifying the business message. This business transaction header is a WSDL part, which is used for the logical separation of the message data. The business transaction header component 525 is based on a business transaction header type component 530, which is defined as an XSD datatype. The business transaction object component 535 defines the leading object in the message (e.g., a purchase order) and is also a WSDL part. The business transaction object component 535 is based on a business transaction object type component 540, which is defined as an XSD datatype. The business transaction object type component 540 includes a business transaction object part component 545, which is a part of the leading object in the message (e.g., an item in a purchase order). The business transaction object component 535 is logically separated into parts defined by the WSDL part. The business transaction object part component 545 is based on a business transaction object part type component 550, which is defined as am XSD datatype.

Each of the components in a business collaboration model are named in accordance with consistent naming conventions. The naming conventions are primarily based on the UMM meta model and are represented according to UN/CEFACT Core Components Technical Specification (CCTS)—Part 8 of the ebXML Framework—Dictionary Entry Name and ISO 11179—Meta Repository—conventions. The names of components can also be represented by an implementation name, which is a modified version of the dictionary entry name used for the XSD types, XSD elements, XML elements and WSDL elements. The representation of both the dictionary entry name and the implementation name uses UpperCamelCase conventions, in which each term or qualified addition starts with a capital letter.

The dictionary entry name uses the separation characters “.” (dot+white space) for the separation of terms and the separation characters “_” (underscore+white space) for the separation of qualified additions to the terms. Qualified additions are placed at the left hand side of a term.

For purposes of illustrating the naming conventions, abbreviations of each term or qualified addition are represented in angle brackets (e.g., <TrP>). Optional terms or qualified additions are preceded with a question mark “?” (e.g., ?<Trp>). An optional qualifier (i.e., ?<ObjQ>) is at least one term and can specify the business object in an unambiguous semantic meaning. The qualifier is represented as prefix and in the UpperCamelCase convention without separation signs, like underscore (e.g. “ReceivedDelivery” for a delivery which has been received) in the implementation name. An object term (i.e., <Obj>) is a name of a business object. A transaction pattern term (i.e., <TrP>) corresponds to the transaction patterns and transaction activities of UMM (see FIG. 2). For synchronous operations, the transaction pattern term corresponds to a transaction pattern, and for asynchronous operations the transaction pattern term corresponds to a transaction activity. Allowed terms include “Transaction,” “RequestResponse,” “QueryResponse,” “RequestConfirmation,” “Request,” “Response,” “Query,” “Confirmation,” “Notification,” and “Information.”

A message direction term (i.e., <Dir>) is used to define whether a message interface is incoming or outgoing. Allowed terms include “In,” and “Out.” An action term (i.e., <Act>) is a qualified addition that defines an instruction to the recipient of a message telling the recipient how to process a transmitted business object. Allowed action terms include “Create,” “Change,” “Cancel,” “None,” and “Remove.” An intention term (i.e., <Int>) is a qualified addition that defines the sender's intent with respect to a business object. Allowed qualified additions include “Accept,” “Assert,” “Declare,” “Propose,” “Publish,” “Reject,” “Reply,” and “Update.” A transaction activity term (i.e., <TrA>) corresponds to the UMM transaction activities. Allowed terms include “Confirmation,” “Information,” “Notification,” “Query,” “Request,” “Response,” and “Transaction.”

The message interface component 505 is identified by a name that includes an optional object qualifier term, an object term, a transaction pattern term, and a direction term. The operation component 510 is identified by a name that includes an optional action term, an optional intent term, and a transaction activity term. The message type component 515 is identified by a name that includes an optional object qualifier term, an object term, an optional action term, an optional intent term, and a transaction activity term.

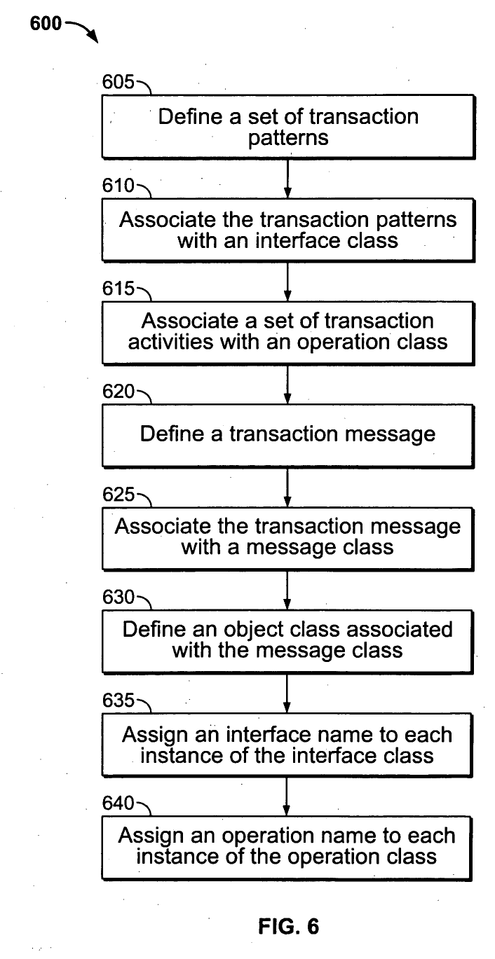

As shown in FIG. 6, a process 600 for modeling a business collaboration includes defining a set of transaction patterns (605). Each transaction pattern includes two transaction activities for two-way communications or one transaction activity for one-way communications. The transaction activities are included in a set of transaction activities. The transaction patterns are associated with an interface class in a web services architecture (610). Each instance of the interface class corresponds to a transaction pattern from the set of transaction patterns. The transaction activities ate associated with an operation class in the web services architecture (615). Each instance of the operation class is associated with one or more instances of the interface class, and each instance of the operation class corresponds to a transaction activity from the set of transaction activities. A transaction message representing information exchanged in the business collaboration is defined (620). The transaction message is associated with a message class in the web services architecture (625). The message class represents at least one message type for each instance of the operation class. An object class representing an object associated with each instance of the message class is defined (630). An interface name is assigned to each instance of the interface class (635). The interface name includes a term associated with the business transaction pattern that corresponds to the instance of the interface class. An operation name is assigned to each instance of the operation class (640). The operation name includes a term associated with the business transaction activity that corresponds to the instance of the operation class.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments, but other embodiments can be implemented and are within the scope of the following claims. For example, the invention can be used in connection with a controlled library of terms for identifying existing and reusable parts that match particular business requirements. Other embodiments are within the scope of the following claims.

What is claimed is:

1. A data structure, stored on a computer-readable medium, defining a data model, the data model comprising:
an interface class for web services, the interface class including at least one operation and each instance of the interface class corresponding to a business transaction pattern of a business collaboration, the business transaction pattern including at least one business transaction activity;
an operation class representing at least one operation associated with an instance of the interface class, each instance of the operation class corresponding to a business transaction activity of the business collaboration; and
a message class representing at least one message type for each instance of the operation class.

2. The data structure of claim 1 wherein the data model comprises a naming convention for components of a business transaction, each business transaction conforming to the naming convention comprising component terms identifying at least one of an intention, an action, a transaction activity, or an object associated with the business transaction.

3. The data structure of claim 2 wherein a message name associated with an instance of the message class includes component terms identifying an intention, an action, a transaction activity, and an object associated with the business transaction.

4. The data structure of claim 2 wherein the component terms include an intention term identifying the intention, an action term identifying the action, and a transaction term identifying the transaction activity, the intention term selected from a predefined set of intention terms, the action term selected from a predefined set of action terms, and the transaction term selected from a predefined set of transaction terms.

5. The data structure of claim 1 wherein the data model comprises a naming convention for components of a business transaction, the naming convention comprising:
assigning an interface name to each instance of the interface class, the interface name including a term associated with the business transaction pattern corresponding to the interface class instance; and
assigning an operation name to each instance of the operation class, the operation name including a term associated with the business transaction activity corresponding to the operation class instance.

6. The data structure of claim 1 wherein the message class corresponds to a business transaction message of the business collaboration.

7. The data structure of claim 1, the data model further comprising an object class representing an object associated with each instance of the message class.

8. A method for modeling a business collaboration, the method comprising:
defining a plurality of transaction patterns, each transaction pattern including at least one transaction activity of a plurality of transaction activities;
associating the plurality of transaction patterns with an interface class for web services, each instance of the interface class corresponding to one of the plurality of transaction patterns;
associating the plurality of transaction activities with an operation class, each instance of the interface class associated with at least one instance of the operation class and each instance of the operation class corresponding to one of the plurality of transaction activities;
defining a transaction message representing information exchanged in a business collaboration; and
associating the transaction message with a message class representing at least one message type for each instance of the operation class.

9. The method of claim 8 further comprising defining an object class representing an object associated with each instance of the message class.

10. The data structure of claim 9 wherein the object class corresponds to a business transaction object of the business collaboration

11. The method of claim 8 further comprising:
assigning an interface name to each instance of the interface class, the interface name including a term associated with the business transaction pattern corresponding to the interface class instance; and
assigning an operation name to each instance of the operation class, the operation name including a term associated with the business transaction activity corresponding to the operation class instance.

12. The method of claim 8 wherein a message name associated with an instance of the message class includes component terms identifying at least one of an intention, an action, a transaction activity, or an object associated with the business transaction.

13. The method of claim 8 wherein the business collaboration is represented by a semantic model and the web services are modeled by the interface class, the operation class, and the message class, each component of the semantic model corresponding to a class of the web services model.

14. The method of claim 8 wherein the business transaction pattern is included in a set of predefined transaction patterns.

15. The method of claim 14 wherein each predefined transaction pattern includes at least one corresponding predefined transaction activity.

16. A system for developing applications, the system comprising a repository including data conforming to a data model, the data model comprising:
an interface class for web services, the interface class including at least one operation and each instance of the interface class corresponding to a business transaction pattern of a business collaboration, the business transaction pattern including at least one business transaction activity;
an operation class representing at least one operation associated with an instance of the interface class, each instance of the operation class corresponding to a business transaction activity of the business collaboration; and
a message class representing at least one message type for each instance of the operation class.

17. The system of claim 16 wherein the data model comprises a naming convention for components of a business transaction, each business transaction conforming to the naming convention comprising component terms identifying an intention, an action, a transaction activity, and an object associated with the business transaction.

18. The system of claim 16 wherein each instance of the interface class includes an interface name comprising component terms identifying:
the business transaction pattern corresponding to the interface class instance; and
a business object associated with the interface class instance.

19. The system of claim 16 wherein each instance of the operation class includes an operation name comprising a component term identifying the business transaction activity corresponding to the operation class instance.

20. The system of claim 16 wherein each instance of the message class includes a message name comprising a component term identifying:
the business transaction activity corresponding to an operation class instance associated with the message class instance; and
a business object associated with the message class instance.

21. A system for developing applications, the system comprising:
a repository storing meta data defining a data model;
a computer for retrieving meta data from the repository and generating a message in accordance with the retrieved meta data, the message comprising:
an instance of an interface class including at least one operation, the instance of the interface class corresponding to a business transaction pattern of a business collaboration, the business transaction pattern including at least one business transaction activity;
an instance of an operation class representing at least one operation associated with the instance of the interface class, the instance of the operation class corresponding to a business transaction activity of the business collaboration; and
an instance of a message class representing at least one message type for the instance of the operation class.

22. The system of claim 21 wherein the message is generated in accordance with a naming convention for components of a business transaction, each business transaction conforming to the naming convention comprising component terms identifying an intention, an action, a transaction activity, and an object associated with the business transaction.

23. The system of claim 21 wherein the message further comprises an instance of an object class representing an object associated with the instance of the message class.
